(19) United States
(12) Patent Application Publication
(10) Pub. No.: US 2007/0134610 A1
(43) Pub. Date: Jun. 14, 2007

(54) ORTHODONTIC ARTICLES WITH ZIRCONIUM OXIDE COATINGS

(75) Inventors: William E. Wyllie II, Pasadena, CA (US); David S. Arney, St. Paul, MN (US); Glenys A. Thorstenson, Azusa, CA (US); Brian J. Gates, Eagan, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/610,530

(22) Filed: Dec. 14, 2006

Related U.S. Application Data
(60) Provisional application No. 60/743,031, filed on Dec. 14, 2005.

(51) Int. Cl. A61C 3/00

(52) U.S. Cl. 433/8; 433/20

(57) ABSTRACT

The present invention is an orthodontic article comprising a substrate and a coating disposed on at least a portion of the substrate, the coating comprising crystalline zirconium oxide.

### CROSS-REFERENCE TO RELATED APPLICATION(S)

Priority is claimed to provisional application Ser. No. 60/743,031, filed on Dec. 14, 2005, and entitled “Orthodontic Articles With Low-Resistance Coatings”. Reference is also hereby made to co-pending patent application Ser. No ______, filed on even date (attorney docket 61122US005), and entitled “Orthodontic Articles With Silicon Nitride Coatings”.

### BACKGROUND OF THE INVENTION

The present invention relates generally to dental articles for use in orthodontic treatment to correct malocclusions. In particular, the present invention relates to orthodontic articles, such as brackets and arch wires, which contain low-resistance coatings.

Orthodontic treatment is directed to the movement of teeth to improved positions for enhancing a patient's facial appearance, especially in areas near the front of the patient's mouth. Orthodontic treatment may also improve the patient's occlusion so that the teeth function better with each other during mastication.

One type of orthodontic treatment system includes a set of tiny articles known as brackets, which are fixed to the patient's anterior, cuspid, and bicuspid teeth. Each of the brackets has a slot to receive a resilient wire, known as an arch wire. The arch wire functions as a track to guide movement of the brackets, and hence movement of the associated teeth, to desired positions. Ends of the arch wire are typically received in passages of small appliances known as buccal tubes that are fixed to the patient's molar teeth.

Orthodontic brackets are available in a variety of materials, such as metallic materials (e.g., stainless steel), plastic materials (e.g., polycarbonate), and ceramic materials. Ceramic materials, such as monocrystalline and polycrystalline alumina, are particularly popular because they may provide brackets that are transparent or translucent. The transparent or translucent appearance reduces the visibility of the brackets, thereby preserving aesthetic qualities. However, ceramic materials typically exhibit a galling effect with arch wires, where the hard ceramic materials of the bracket grind notches into the relatively soft materials of the arch wire during use. The notches effectively function as barriers that inhibit the motion of the bracket along the arch wire. As a result, the galling may slow the movement of the teeth, which may accordingly lengthen treatment time. As such, there is a need for orthodontic articles that reduce galling, exhibit low levels of frictional resistance, and retain good aesthetic qualities.

### BRIEF SUMMARY OF THE INVENTION

The present invention is an orthodontic article that includes a substrate and a coating disposed on at least a portion of the substrate, where the coating includes crystalline zirconium oxide. The present invention also relates to a method of manufacturing the orthodontic article.

### BRIEF DESCRIPTION OF THE DRAWINGS

FIG. 1 is a front view of teeth of an exemplary patient undergoing orthodontic treatment with an orthodontic appliance of the present invention.

FIG. 2 is a top perspective view of a bracket of the orthodontic appliance of the present invention.

FIG. 3 is a sectional view of section 3-3 taken in FIG. 2, showing cross-sectional components of the bracket.

FIG. 4 is a sectional view of an arch wire of the orthodontic appliance of the present invention, showing cross-sectional components of the arch wire.

While the above-identified drawing figures set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale. Like reference numbers have been used throughout the figures to denote like parts.

### DETAILED DESCRIPTION

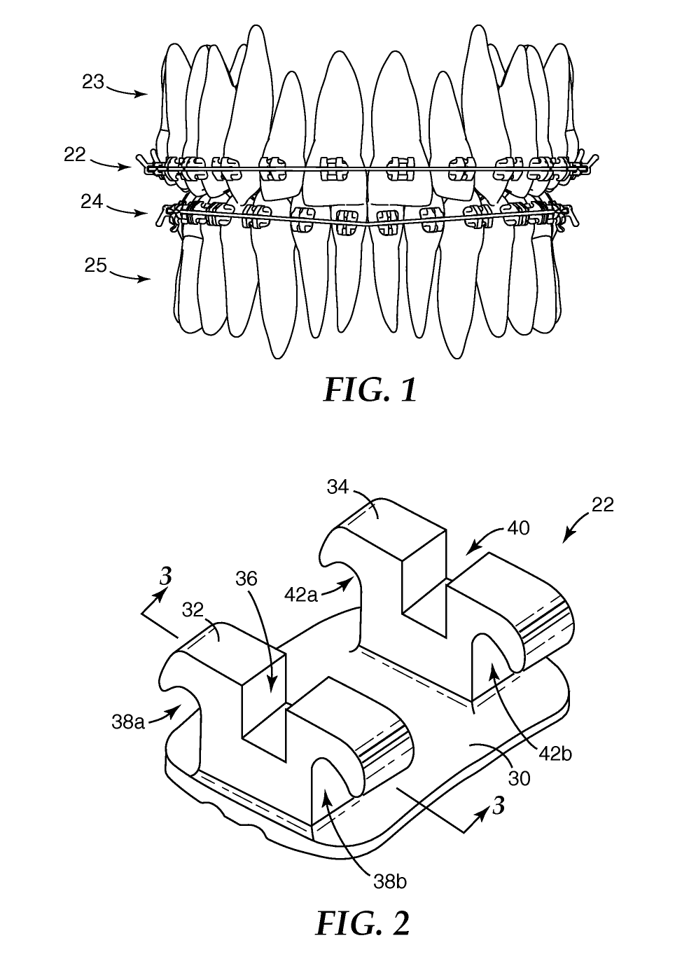

FIG. 1 is a front view of teeth 10 undergoing orthodontic treatment with orthodontic appliance 12 of the present invention. Teeth 10 include upper dental arch 14 and lower dental arch 16. Correspondingly, orthodontic appliance 12 includes upper orthodontic brace 18 and lower orthodontic brace 20, which are respectively connected to upper dental arch 14 and lower dental arch 16 to provide the orthodontic treatment.

Upper orthodontic brace 18 includes a plurality of brackets 22 and arch wire 24. Each bracket 22 is bonded to a single tooth of upper dental arch 14 and arch wire 24 extends around upper dental arch 14 to engage with each bracket 22. Similarly, lower orthodontic brace 20 includes a plurality of brackets 26 and arch wire 28, where each bracket 26 is bonded to a single tooth of lower dental arch 16, and arch wire 28 extends around lower dental arch 16 to engage with each bracket 26. Arch wires 24 and 28 function as tracks to guide the movement of brackets 22 and 26 to desired positions during the orthodontic treatment.

As discussed below, one or more of brackets 22 and 26 and arch wires 24 and 28 contain crystalline zirconium oxide (ZrO₂) coatings to assist in the sliding mechanics of the orthodontic treatment. In particular, the coatings reduce galling and frictional resistance between brackets 22 and arch wire 24, and between brackets 26 and arch wire 28. As a result, when a practitioner adjusts arch wire 24 during the orthodontic treatment, brackets 22 and the associated teeth shift along the longitudinal length of arch wire 24 under the influence of induced forces selected by the practitioner. The reduced galling and friction provided by the coatings permits brackets 22 to more easily shift along arch wire 24. This reduces time and effort required to complete the orthodontic treatment.

FIG. 2 is a top perspective view of an individual bracket 22. For ease of discussion, FIGS. 2-4 refer only to the components of upper orthodontic brace 18 (i.e., brackets 22 and arch wire 24). However, it is understood that such disclosure applies equally to the components of lower orthodontic brace 20 (i.e., brackets 26 and arch wire 28). As shown in FIG. 2, bracket 22 includes base 30 and tiewings 32 and 34. Base 30 is the portion of bracket 22 that bonds to a tooth surface. Tiewings 32 and 34 are a pair of wing-like structures integrally connected to base 30 for retaining arch wire 24 (not shown). In alternative embodiments, the pair of tiewings 32 and 34 may be replaced with merged tiewings or a single tiewing for retaining arch wire 24.

The dimensions of tiewing 32 define slot 36 and ligature recesses 38a and 38b. Similarly, the dimensions of tiewing 34 define slot 40 and ligature recesses 42a and 42b. Slots 36 and 40 are the portions of bracket 22 that engage arch wire 24, and contain the coatings for reducing friction between bracket 22 and arch wire 24. Ligature recesses 38a, 38b, 42a, and 42b are configured to receive a standard elastomeric or wire ligature for retaining arch wire 24 within slots 36 and 40.

In use, a practitioner may place a portion of arch wire 24 within slots 36 and 40 to interconnect each bracket 22 within upper orthodontic brace 18. A ligature may then be placed over arch wire 24 and into recesses 38a and 38b behind tiewing 32 and recesses 42a and 42b behind tiewing 34. This secures arch wire 24 within slots 36 and 40. When the practitioner adjusts arch wire 24 during the orthodontic treatment, the reduced galling and friction provided by the coatings in slots 36 and 40 permits bracket 22 to more easily shift along arch wire 24. This reduces the time and effort required to complete the orthodontic treatment.

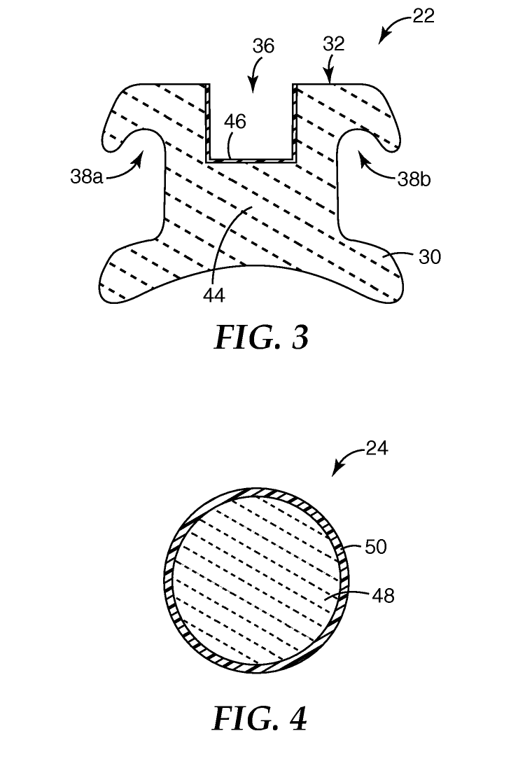

FIG. 3 is a front sectional view of section 3-3 in FIG. 2, which shows the cross-sectional components of bracket 22. As shown, bracket 22 includes substrate 44 and coating 46. Substrate 44 is the bulk of bracket 22, and may compositionally include a variety of materials. Examples of suitable materials for substrate 44 include metallic materials (e.g., stainless steel), plastic materials (e.g., polycarbonate), and ceramic materials (e.g., monocrystalline and polycrystalline alumina). Examples of particularly suitable materials for substrate 44 include ceramic materials having good optical properties, such as those disclosed in Kelly et al., U.S. Pat. No. 4,954,080 and Castro et al., U.S. Pat. No. 6,648,638. Substrate 44 may be formed with standard techniques for manufacturing orthodontic brackets. Alternatively, substrate 44 may be a commercially available orthodontic bracket that is subsequently treated to include coating 46. Examples of suitable commercially available orthodontic brackets include the trade designated “TRANSCEND” and “CLARITY” series ceramic brackets, which are available from 3M Unitek Corporation, Monrovia, Calif. In one embodiment, such as with the trade designated “CLARITY” series ceramic bracket, substrate 44 may include a separate liner (not shown) secured within slot 36 (and slot 40, shown in FIG. 2). Suitable materials for the separate liner include those discussed above for substrate 44.

Coating 46 is a layer that substantially covers substrate 44 within slot 36, thereby providing a low coefficient of friction within slot 36. A second portion of coating 46 (not shown) also substantially covers substrate 44 within slot 40 in the same manner. Coating 46 preferably extends across at least two surfaces of each of slots 36 and 40, and more preferably extends across all three surfaces of each of slots 36 and 40. Placing coating 46 within slots 36 and 40 reduces galling and the frictional resistance at the engagement locations between bracket 22 and arch wire 24. This allows bracket 22 to easily shift relative to arch wire 24 during adjustments. In alternative embodiments, coating 46 may also cover substrate 44 at other locations of bracket 22, if desired. For example, coating 46 may be deposited over substantially the entire outer surface of substrate 44, with the exception of the bottom surface of base 30, which bonds to a tooth.

Coating 46 compositionally includes crystalline zirconium oxide (ZrO₂), which provides a low-resistance coating that is substantially clear (i.e., substantially transparent and colorless) to the naked eye. The term “crystalline” for the zirconium oxide of coating 46 refers to a monocrystalline or a polycrystalline state in which the zirconium oxide molecules are at least substantially arranged in a regularly ordered, repeating pattern extending in all three spatial dimensions. This is in contrast to non-crystalline materials that have no long-range order, such as amorphous, vitreous, and glassy materials.

Suitable color measurements for coating 46 relative to substrate 44 include ΔE values of about 4.0 or less for white and black reflectance standard backgrounds, with particularly suitable color measurements including ΔE values of about 2.0 or less, and with even more particularly suitable color measurements including ΔE values of about 1.0 or less. As discussed below, the ΔE value is based on the Commission Internationale de l'Eclairage (CIE) L*a*b* scoring system. From the perspective of a typical viewer, a ΔE value of about three is about the limit of visual distinction in color. Furthermore, as discussed in Y. K. Lee et al., “Color and Translucency of Resin Composites after Curing, Polishing, and Thermocycling” Operative Dentistry, 2005 30-4, pp. 436-442; and in N. John, “Spectrophotometers and Delta-E: Your color ruler”, Newspapers & Technology, www.newsandtech.com, Conley Magazines, LLC, June 2006, ΔE values of about four are considered only minor color changes.

In addition to being substantially clear, coating 46 also prevents direct contact between the material of substrate 44 and the material of arch wire 24. This effectively prevents the material of substrate 44 from grinding notches in the materials of arch wire 24, thereby reducing the galling effect. In contrast to coating 46, coatings formed from zirconium nitride (ZrN) exhibit metallic tints that detract from the aesthetic qualities of the underlying substrates. However, because coating 46 compositionally includes crystalline zirconium oxide, coating 46 preserves the aesthetic appeal of substrate 44 while also improving the sliding mechanics. This is particularly beneficial where substrate 44 compositionally includes a ceramic material that exhibits good optical properties.

Crystalline zirconium oxide may be deposited as a thin film, while still reducing galling and providing a low-frictional surface. Examples of suitable layer thicknesses for coating 46 include about 10 micrometers or less, with particularly suitable layer thicknesses including about 5 micrometers or less, and with even more particularly suitable layer thicknesses including about 1 micrometer or less. The thin layers for coating 46 are beneficial because substrate 44 may be formed without taking the thickness of coating 46 into consideration. This allows the use of commercially available brackets for substrate 44 without modifications to account for the thickness of coating 46.

Prior to deposition, substrate 44 may undergo surface treatments, such as plasma etching and reactive ion etching, to provide good bonding between substrate 44 and coating 46. Coating 46 may then be deposited on substrate 44 in a variety of manners. Examples of suitable deposition techniques include chemical vapor deposition, plasma-enhanced chemical vapor deposition, sputter coating, e-beam reactive coating, and combinations thereof. Metallic and ceramic mask features may be used to limit the deposition to slots 36 and 40.

Particularly suitable deposition techniques for forming coating 46 include reactive sputter coating using a zirconium metal target, firing a thin coating of zirconia powder to create a crystalline zirconium oxide layer (i.e., zirconia-powder firing), plasma spray deposition (e.g., with glazing and firing), sputter coating from a zirconium oxide target, evaporation coating from a zirconium oxide target, and combinations thereof. In one embodiment, coating 46 is formed with a zirconium metal target electrode in a reduced-pressure atmosphere of argon and oxygen. The zirconium metal target electrode is biased with a charge to provide zirconium atoms that deposit with oxygen atoms to form monocrystalline and/or polycrystalline structures of zirconium oxide. The deposition process continues for a sufficient duration to form a suitable layer thickness of the crystalline zirconium oxide, thereby forming coating 46. After being deposited, coating 46 may also undergo post-deposition treatments, such as polishing, to enhance the aesthetic qualities of bracket 22.

FIG. 4 is a sectional view of arch wire 24, taken in a plane perpendicular to the longitudinal length of arch wire 24, which depicts an alternative embodiment of the present invention. As shown, arch wire 24 contains substrate 48 and coating 50. Substrate 48 is a standard arch wire substrate, and may compositionally include a metallic material, such as stainless steel, beta-titanium, and Nitinol (i.e., a nickel-titanium shape-memory alloy). While arch wire 24 is shown in having a round cross-sectional configuration in FIG. 4, arch wire 24 may alternatively exhibit other geometric cross-sections (e.g., a square or rectangular cross-section). Coating 50 is a crystalline zirconium oxide (ZrO₂) coating deposited substantially around the entire surface of substrate 48. Examples of suitable materials and layer thicknesses for coating 50 are the same as those discussed above for coating 46 (shown in FIG. 3). The materials may also be deposited in the same manner as discussed above to provide a thin layer substantially surrounding substrate 48.

In this embodiment, arch wire 24 contains coating 50 for reducing galling and frictional resistance between bracket 22 and arch wire 24. As a result, bracket 22 may be a standard orthodontic bracket. The thin layer of coating 50 allows the use of arch wire 24 with standard orthodontic brackets without requiring modifications to the slots to retain arch wire 24. When the practitioner adjusts arch wire 24 during the orthodontic treatment, the reduced galling and frictional resistance provided by coating 50 permits bracket 22 to more easily shift along arch wire 24. This reduces time and effort required to complete the orthodontic treatment in the same manner as discussed above for bracket 22 in FIGS. 2 and 3.

In another alternative embodiment, bracket 22 may include coating 46, as discussed above, and arch wire 24 may contain coating 50. This further reduces galling and the frictional resistance between bracket 22 and arch wire 24 by having coating 46 contact coating 50 when arch wire 24 engages bracket 22. Accordingly, orthodontic appliance 12 of the present invention may include a variety of orthodontic articles, such as brackets (e.g., brackets 22 and 26) and arch wires (e.g., arch wires 24 and 28) that contain crystalline zirconium oxide coatings. This allows the brackets to more easily shift along the arch wires during adjustments by practitioners, thereby reducing time and effort required for orthodontic treatments.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

### Examples 1 and 2 and Comparative Example A

Orthodontic brackets of Examples 1 and 2 and Comparative Example A were each prepared pursuant to the following procedure using an orthodontic bracket commercially available under the trade designation “TRANSCEND” ceramic upper cuspid brackets with hook, part no. 6001-706, from 3M Unitek Corporation, Monrovia, Calif. The sample ceramic bracket of Comparative Example A was an uncoated bracket, in which the wire slot was exposed, without a zirconium oxide coating.

The sample ceramic brackets of Examples 1 and 2 were each prepared pursuant to the following procedure. A crystalline zirconium oxide coating was deposited using the trade designated “Research S-Gun”, turbo-pumped vacuum system. A sample ceramic bracket was placed onto the metal planets (which revolve and rotate providing uniformity to the coatings) that function as sample holders, and the sample ceramic bracket was masked so that only the archwire slot was exposed to deposition.

After pumping to base pressure, argon and oxygen gases were introduced to the chamber at flow rates of 25 sccm and 15 sccm, respectively. A series of vanes attached to the turbo pump were partly closed to limit pumping speed and raise chamber pressure during the deposition process to 4 mTorr. A circular, zirconium metal target electrode at 1.5 Amps power (target bias is −350 Volts to −400 Volts) was used to provide the zirconium atoms for the coating. The planetary system was RF biased with nominally 20-50 Watts at a frequency of 13.56 MHz. Zirconium oxide was then deposited onto the sample ceramic brackets over a sufficient deposition time to form a 0.25-micrometer thick crystalline zirconium oxide coating for Example 1, and a 0.49-micrometer thick crystalline zirconium oxide coating for Example 2.

The sample ceramic brackets of Examples 1 and 2 and Comparative Example A were each quantitatively measured for color pursuant to the following procedure. The color measurements were performed to record the color of the sample ceramic bracket as it appears on white and black reflectance standard backgrounds. The backgrounds were commercially under the trade designations “SRS-99-010” white reflectance standard background and “SRS-02-010” black reflectance standard background, from Labsphere, Inc., North Sutton, N.H.

The color measurements were performed using a trade designated “X-RITE SP64” integrating sphere spectrophotometer, using ColorMaster software, which was commercially available from X-Rite, Inc., Grandville, Mich. A sample ceramic bracket was placed on the reflectance standard background (white or black), within a 4-millimeter diameter test aperture. This procedure measured the appearance of the bracket as well as a small portion of the reflectance standard background. A Light Source D65 (6504 Kelvin light) with an observer angle of ten degrees was used (this setting is typically represented as D65/10°). The data was recorded for Specular reflection excluded (SPEX) to minimize gloss effects.

The color measurement system relied on the Commission Internationale de l'Eclairage (CIE) L*a*b* scoring system. The system measured L lightness (L*), red/green (a*), and yellow/blue (b*) for each sample ceramic bracket. The overall difference between samples is expressed as a ΔE value:
ΔE*_{ab}=\sqrt{[(ΔL*)²+(Δa*)²+(Δb*)²}] (1)

where ΔL*, Δa*, and Δb* are the differences of the L*, a*, or b* readings of the sample ceramic bracket of Example 2 and the corresponding readings of a test standard. Here, the test standard was the sample ceramic bracket of Comparative Example A, and the readings used for the test standard were the average readings from three separate sample ceramic brackets of Comparative Example A. Table 1 provides the L*, a*, b* readings and the ΔE values for the sample ceramic brackets of Examples 1 and 2 and Comparative Example A, with the use of a “white” reflectance standard background.

TABLE 1

| | L* | | a* | | b* | | |
|---|---|---|---|---|---|---|---|
| | | Std. | | Std. | | Std. | |
| Example | Reading | Dev. | Reading | Dev. | Reading | Dev. | ΔE |
| Example 1 | 91.61 | 0.33 | 0.48 | 0.32 | 3.74 | 1.08 | 0.42 |
| Example 2 | 91.37 | 0.19 | 0.65 | 0.22 | 4.89 | 0.32 | 1.31 |
| Comparative | 91.91 | 0.22 | 0.78 | 0.14 | 3.71 | 0.38 | 0.00 |
| Example A | | | | | | | |

Table 2 provides the L*, a*, b* readings and the ΔE values for the sample ceramic brackets of Examples 1 and 2 and Comparative Example A, with the use of a “black” reflectance standard background.

TABLE 2

| | L* | | a* | | b* | | |
|---|---|---|---|---|---|---|---|
| | | Std. | | Std. | | Std. | |
| Example | Reading | Dev. | Reading | Dev. | Reading | Dev. | ΔE |
| Example 1 | 66.70 | 1.03 | −0.22 | 0.21 | 2.04 | 0.88 | 0.94 |
| Example 2 | 67.11 | 0.58 | −0.24 | 0.18 | 2.61 | 0.22 | 1.54 |
| Comparative | 65.89 | 0.38 | 0.16 | 0.09 | 1.76 | 0.35 | 0.00 |
| Example A | | | | | | | |

The results shown in Tables 1 and 2 illustrate the good aesthetic qualities of the sample ceramic brackets of Examples 1 and 2. A comparison of the ΔE values between the sample ceramic brackets of Examples 1 and 2 show that the brackets having lower coating thicknesses (i.e., Example 1) exhibited lower ΔE values relative to the brackets having thicker coatings (i.e., Example 2). Nonetheless, the difference in color between the sample ceramic brackets of Examples 1 and 2 and Comparative Examples A were small. As discussed above, from the perspective of a typical viewer, a ΔE value of about three is about the limit of visual distinction. In comparison, the sample ceramic brackets of Examples 1 and 2 exhibited ΔE values less than this limit.

Additionally, the sample ceramic brackets were viewed without the use of arch wires, which are normally present during orthodontic treatment. An arch wire typically rests in the coated wire slot and will cover a substantial portion of the coating. Outside of the wire slots, the sample ceramic brackets of Examples 1 and 2 were visually identical to the uncoated sample ceramic bracket of Comparative Example A. Accordingly, the crystalline zirconium oxide coating of the present invention preserved the visual aesthetic qualities of the underlying ceramic bracket.

### Examples 3-5 and Comparative Example B

Orthodontic brackets of Examples 3-5 and Comparative Example B were each prepared and measured to determine their static and dynamic coefficients of friction when a normal (i.e., ligation) force is applied to a corresponding archwire. The orthodontic bracket of Comparative Example B was an uncoated ceramic bracket prepared pursuant to Castro et al., U.S. Pat. No. 6,648,638, in which the wire slot was exposed, without a zirconium oxide coating. Ten sample brackets of Comparative Example B were tested for static and dynamic coefficients of friction.

Orthodontic brackets of Examples 3-5 were each prepared pursuant to the procedure discussed above for the orthodontic brackets of Example 1 and 2, except that the ceramic brackets were prepared pursuant to Castro et al., U.S. Pat. No. 6,648,638, and where the orthodontic brackets of Examples 3-5 included crystalline zirconium oxide coatings having thicknesses of 0.29 micrometers, 0.49 micrometers, and 1.05 micrometers, respectively. Five sample brackets for each of Examples 3-5 were tested for static and dynamic coefficients of friction.

A stainless-steel archwire was then coupled to each sample bracket, where each archwire was a straight length of resilient rectangular wire, part no. 253-825 (available from 3M Unitek Corporation, Monrovia, Calif.), having dimensions of 460 micrometers×640 micrometers (0.018 inches×0.025 inches). Each sample bracket was then bonded to a steel stub using a primer and an adhesive such that the effects of prescription were negated. The primer and the adhesive used were commercially available under the trade designations “SCOTCHPRIME” and “TRANSBOND XT”, respectively, both from 3M Unitek Corporation, Monrovia, Calif. The steel stub was then locked into a custom frictional testing apparatus in an MTS Q-Test mechanical testing machine, available from MTS Systems Corporation, Eden Prairie, Minn.

For each archwire-bracket couple, nominal normal forces of 400 grams, 600 grams, 100 grams, 300 grams, 200 grams, and 500 grams were applied to the archwire on the mesial and distal sides of the bracket via two 360-micrometer (0.014-inch) diameter stainless steel ligature wires. All frictional tests were in the dry state (i.e., in the absence of saliva). The normal forces were monitored with a transducer commercially available under the trade designation “ATI NANO 17 DAQ F/T Transducer” from ATI Industrial Automation, Inc., Apex, N.C. The drawing force used to pull the archwire through the bracket was measured by a 100-Newton load cell.

The average normal force and frictional force were then calculated for static friction and dynamic friction, where the frictional force equaled half of the drawing force. For each set of orthodontic brackets of Examples 3-5 and Comparative Example B, the static frictional forces were plotted as a function of the applied normal forces, and a linear regression line was generated. The static coefficient of friction for each orthodontic bracket-archwire couple was then calculated as the slope of the linear regression line (i.e., static frictional force/normal force). Outlier results not meeting an R² correlation coefficient of 0.80 or greater relative to the linear regression line were excluded from the analysis. The same analysis was also used to determine the dynamic coefficient of friction as a slope of the dynamic frictional force/normal force. Table 3 provides the average static and dynamic coefficients of friction, and the corresponding standard deviations, for the orthodontic brackets of Examples 3-5 and Comparative Example B.

TABLE 3

| | | Static | Dynamic |
|---|---|---|---|
| | Coating | Coefficient | Coefficient |
| | Thickness | of Friction | of Friction |
| Example | (micrometers) | (kg/kg) | (kg/kg) |
| Example 3 | 0.29 | 0.23 ± 0.03 | 0.23 ± 0.03 |
| Example 4 | 0.49 | 0.29 ± 0.07 | 0.28 ± 0.06 |
| Example 5 | 1.05 | 0.31 ± 0.12 | 0.32 ± 0.12 |
| Comparative | N/A | 0.26 ± 0.06 | 0.26 ± 0.06 |
| Example B | | | |

The results shown in Table 3 illustrate the low static and dynamic coefficients of friction for orthodontic brackets of the present invention. As shown, the sample brackets of Example 3 exhibited lower average static coefficients of friction compared to the uncoated bracket of Comparative Example B, where the uncoated bracket of Comparative Example B was a fine-grain ceramic bracket. Additionally, the results show a trend where the lower coating thicknesses exhibited lower average static and dynamic coefficients of friction. As discussed above, thin layers for the crystalline zirconium oxide coatings are also beneficial because the orthodontic article may be formed without taking the thickness of the coating into consideration. This allows the use of commercially available brackets without modifications to account for the thickness of the coatings. Moreover, the coatings for the brackets of Examples 3-5 prevented direct contact between the bracket and the arch wire, thereby preventing the ceramic materials of the brackets from grinding notches in the arch wires. This accordingly reduced the galling effects.

Although the present invention has been described with reference to preferred embodiments, workers skilled in the art will recognize that changes may be made in form and detail without departing from the spirit and scope of the invention. For example, the coating described above (e.g., coatings 46 and 50) may be applied to other orthodontic articles, including self-ligating orthodontic brackets and orthodontic buccal tubes.

1. An orthodontic article comprising:
a substrate of the orthodontic article; and
a coating disposed on at least a portion of the substrate, the coating comprising crystalline zirconium oxide.

2. The orthodontic article of claim 1, wherein the orthodontic article is selected from the group consisting of an orthodontic bracket and an orthodontic arch wire.

3. The orthodontic article of claim 1, wherein the orthodontic article comprises a ceramic bracket.

4. The orthodontic article of claim 1, wherein the coating exhibits a ΔE value of about 4.0 or less relative to the substrate for a reflectance standard background selected from the group consisting of a white reflectance standard background and a black reflectance standard background.

5. The orthodontic article of claim 1, wherein the coating has a layer thickness of about 10 micrometers or less.

6. The orthodontic article of claim 5, wherein the layer thickness of the coating is about 5 micrometers or less.

7. The orthodontic article of claim 6, wherein the layer thickness of the coating is about 1 micrometer or less.

8. An orthodontic system comprising:
an orthodontic bracket having at least one archwire slot, wherein the orthodontic bracket comprises:
a bracket substrate; and
a first coating disposed on the bracket substrate within the at least one archwire slot, the first coating comprising crystalline zirconium oxide; and
an orthodontic arch wire configured to engage the orthodontic bracket at the at least one archwire slot.

9. The orthodontic system of claim 8, wherein the bracket substrate comprises a ceramic material.

10. The orthodontic system of claim 9, wherein the coating exhibits a ΔE value of about 4.0 or less relative to the bracket substrate for a reflectance standard background selected from the group consisting of a white reflectance standard background and a black reflectance standard background.

11. The orthodontic system of claim 8, wherein the first coating has a layer thickness of about 5 micrometers or less.

12. The orthodontic system of claim 11, wherein the layer thickness of the first coating is about 1 micrometer or less.

13. The orthodontic system of claim 8, wherein the orthodontic arch wire comprises a wire substrate and a second coating disposed on at least a portion of the wire substrate, the second coating comprising crystalline zirconium oxide.

14. The orthodontic system of claim 13, wherein the second coating contacts the first coating when the orthodontic arch wire engages the orthodontic bracket at the at least one archwire slot.

15. A method of manufacturing an orthodontic article, the method comprising:
providing a substrate of the orthodontic article; and
depositing a coating on at least a portion of the substrate, the coating comprising crystalline zirconium oxide.

16. The method of claim 15, wherein the substrate comprises a ceramic material.

17. The method of claim 15, further comprising treating the substrate with a process selected from the group consisting of plasma etching and reactive ion etching.

18. The method of claim 15, wherein depositing the coating is selected from the group consisting of chemical vapor deposition, plasma-enhanced chemical vapor deposition, sputter coating, e-beam reactive coating, and combinations thereof.

19. The method of claim 18, wherein depositing the sputter coating comprises biasing a zirconium metal target electrode in an atmosphere comprising oxygen.

20. The method of claim 15, further comprising masking at least a second portion of the substrate.
